(19) United States
(12) Patent Application Publication
(10) Pub. No.: US 2007/0097206 A1
(43) Pub. Date: May 3, 2007

(54) Multi-user stereoscopic 3-D panoramic vision system and method

(76) Inventors: Robert C. Houvener, Hollis, NH (US); Steven N. Pratte, Bedford, NH (US)

Correspondence Address: SCOTT C. RAND, ESQ.;MCLANE, GRAF, RAULERSON & MIDDLETON, PA, 900 ELM STREET, P.O. BOX 326, MANCHESTER, NH, 03105-0326, US

(21) Appl. No.: 11/265,584

(22) Filed: Nov. 2, 2005

(51) Int. Cl. H04N 5/14

(52) U.S. Cl. 348/26

(57) ABSTRACT

A panoramic camera system includes a plurality of camera units mounted in a common, e.g., horizontal, plane and arranged in a circumferential array. Each camera unit includes one or more lenses for focusing light from a field of view onto an array of light-sensitive elements. A panoramic image generator combines electronic image data from the multiplicity of the fields of view to generate electronic image data representative of a first 360-degree panoramic view and a second 360-degree panoramic view, wherein the first and second panoramic views are angularly displaced. A stereographic display system is provided to retrieve operator-selectable portions of the first and second panoramic views and to display the user selectable portions in human viewable form. In a further aspect, a video display method is provided.

### BACKGROUND OF THE INVENTION

The present invention relates generally to the art of sensors and displays. It finds particular application in vision systems for operators of manned and unmanned vehicles and is illustrated and described herein primarily with reference thereto. However, it will be appreciated that the present invention is also amenable to surveillance and other tele-observation or tele-presence applications and all manner of other panoramic or wide-angle video photography applications.

Although it has been possible to collect panoramic images and even spherical images for a number of years, it has not been possible to simultaneously acquire and display data panoramically, at its true resolution, in real-time, as three-dimensional (3-D) stereoscopic images. Nor has it been possible to share non-coincident stereo views of the outside of a vehicle. The lack of these capabilities has severely hampered the ability to implement adequate operator interfaces in those vehicles that do not allow the operator to have direct view of the outside world, such as fighting vehicles like tanks and armored personnel carriers, among many other applications. Personnel often prefer to have themselves partially out of the vehicle hatches in order to gain the best visibility possible, putting them at risk of casualty. In the case of tanks, the risk to such personnel includes being hit by shrapnel, being shot by snipers, getting pinned by the vehicle when it rolls, as well as injuring others and property due to poor visibility around the vehicle as it moves.

Previous attempts at mitigating these problems include the provision of windows, periscopes, various combinations of displays and cameras, but none of these has provided a capability that mitigates the lack of view for the operators. Hence, operators still prefer direct viewing, with its inherent dangers. Windows must be small and narrow since they will not withstand ballistics and hence provide only a narrow field of view. Windows also let light out, which at night pinpoints areas for enemy fire. Periscopes have a narrow field of view and expose the operator to injury, e.g., by being struck by the periscope when the vehicle tosses around. Periscopes may also induce nausea when operators look through them for more than very short periods. Previous attempts with external cameras and internal displays similarly induce nausea, provide a narrow or limited field of view, do not easily accommodate collaboration among multiple occupants, endure significant lag times between image capture and display thereby causing disorientation for the users, do not provide adequate depth perception, and, in general, do not replicate the feeling of directly viewing the scenes in question. Further, when a sensor is disabled, the area covered by that sensor is no longer visible to the operator. Hence as of 2005, vehicle operators are still being killed and injured in large numbers.

In addition, display systems for remotely operated unmanned surface, sub-surface, and air vehicles suffer from similar deficiencies, thereby limiting the utility, survivability, and lethality of these systems.

The current state of the art involves the use of various types of camera systems to develop a complete view of what is around the sensor. For example, the Ladybug camera from PT Grey, the Dodeca camera from Immersive Media Corporation, and the SVS-2500 from iMove, Inc., all do this with varying degrees of success. These and other companies have also developed camera systems where the individual sensors are separated from each other by distances of many feet and the resulting data from the dispersed cameras is again “stitched” together to form a spherical or semi spherical view of what is around the vehicle. Most of these cameras have accompanying software that allows a user to “stitch” together the images from a number of image sensors that make up the spherical camera, into a seamless spherical image that is updated from 5 to 30 times per second. Accompanying software also allows one to “de-warp” portions of the spherical image for users to view in a “flat” view, without the distortion caused by the use of very wide-angle lenses on the cameras that make up the spherical sensors. These systems are generally non-real-time and require a post-processing step to make the images appear as a spherical image, although progress is being made in making this process work in real-time. Unfortunately, tele-observation situations such as viewing what is going on outside of a tank as it is being operated require a maximum of a few hundred milliseconds of latency from image capture to display. Present systems do not provide a stereo 3-D view and, hence, cannot replicate the stereoscopic depth that humans use in making decisions and perceiving their surroundings.

Furthermore, the fielded current state of the art still generally involves the use of pan-tilt type camera systems. These pan-tilt camera systems do not allow for multiple users to access different views around the sensor and all users must share the view that the “master” who is controlling the device is pointing the sensor towards.

Accordingly, the present invention contemplates a new and improved vision system and method wherein a complete picture of the scene outside a vehicle or similar enclosure is presented to any number of operators in real-time stereo 3-D, and which overcome the above-referenced problems and others.

### SUMMARY OF THE INVENTION

In accordance with one aspect, a panoramic camera system includes a plurality of camera units mounted and arranged in a circumferential, coplanar array. Each camera unit includes one or more lenses for focusing light from a field of view onto an array of light-sensitive elements. A panoramic image generator combines electronic image data from the multiplicity of the fields of view to generate electronic image data representative of a first 360-degree panoramic view and a second 360-degree panoramic view, wherein the first and second panoramic views are angularly displaced. A stereographic display system is provided to retrieve operator-selectable portions of the first and second panoramic views and to display the user selectable portions in human viewable form.

In accordance with another aspect, a method of providing a video display of a selected portion of a panoramic region comprises acquiring image data representative of a plurality of fields of view with a plurality of camera units mounted in a common plane and arranged in a circumferential array. Electronic image data from the multiplicity of the fields of view is combined to generate electronic image data representative of a first 360-degree panoramic view and a second 360-degree panoramic view, said first and second panoramic views being angularly displaced with respect to each other. Selected portions of said first and second panoramic views are retrieved and converted into human viewable form.

One advantage of the present development resides in its ability to provide a complete picture of what is outside a vehicle or similar enclosure, to any desired number of operators in the vehicle or enclosure in real-time stereo 3-D.

Another advantage of the present vision system is that it provides image comprehension by the operator that is similar to, or in some cases better than, comprehension by a viewer outside the vehicle or enclosure. For example, since the depicted system allows viewing the uninterrupted scene around the vehicle/enclosure, and it provides high-resolution stereoscopic images to provide a perception of depth, color, and fine detail. In some instances, image comprehension may be enhanced due to the ability to process the images of the outside world and to enhance the view with multiple spectral inputs, brightness adjustments, to see through obstructions on the vehicle, etc.

Another advantage of the present invention is found in the near-zero lag time between the time the scene is captured and the time it is presented to the operator(s), irrespective of the directions(s) the operator(s) may be looking in.

Still another advantage of the present development resides in its ability to calculate the coordinates (e.g., x, y, z) of an object or objects located within the field of view.

Still another advantage of the present invention is the ability to link the scene presented to the operator, the location of objects in the stereo scenes via image processing or operator queuing, the calculation of x, y, z position from the stereo data and finally, the automated queuing of weapons systems to the exact point of interest. This is a critical capability that allows the very rapid return of fire, while allowing an operator to make the final go/no go decision, thereby reducing collateral or unintended damage.

Still further advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a block diagram illustrating a first embodiment of the present invention.

FIG. 2 is a block diagram illustrating a second embodiment of the present invention.

FIG. 3 is an enlarged view of the camera array in accordance with an embodiment of the present invention.

FIG. 4 is a schematic top view of an exemplary camera array illustrating the overlapping fields of view of adjacent camera units in the array.

FIG. 5 illustrates an exemplary method of calculating the distance to an object based on two angularly displaced views.

FIG. 6 is a flow diagram illustrating an exemplary method in accordance with the present invention.

FIG. 7 is a block diagram illustrating a distributed embodiment.

FIG. 8 is a schematic top view of a sensor array, illustrating an alternative method of acquiring angularly displaced panoramic images.

### DETAILED DESCRIPTION OF THE PREFERRED EMBODIMENTS

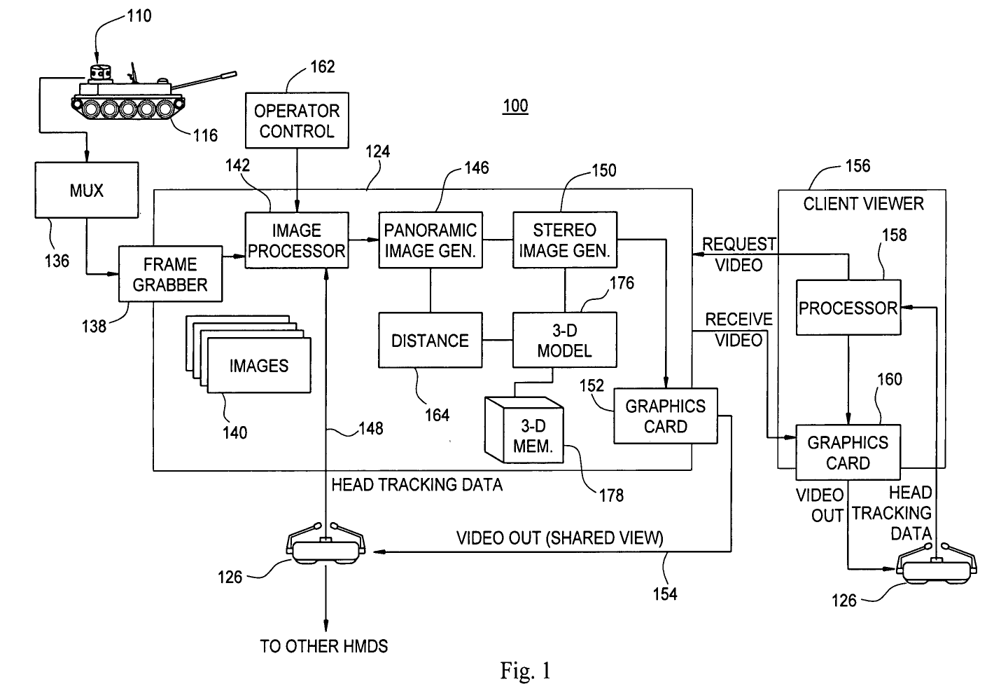

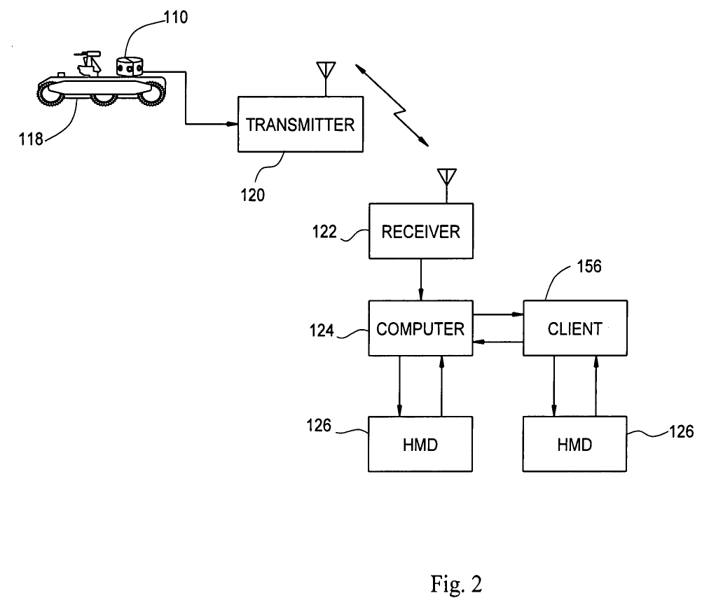

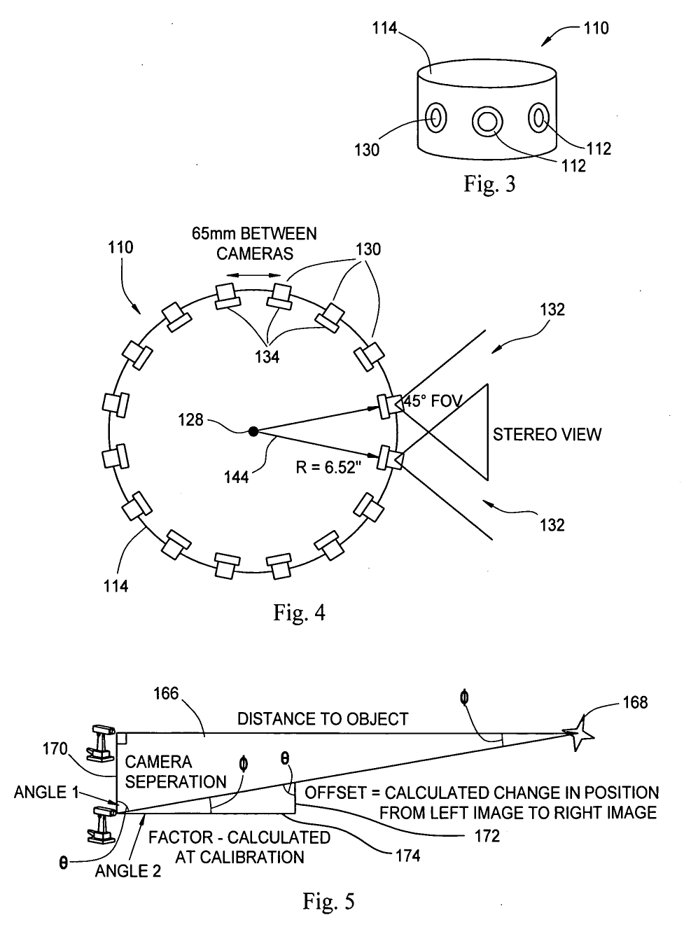

Referring now to the drawing figures, FIG. 1 depicts an exemplary vision system embodiment 100 employing an array 110 of sensors 112. An enlarged view of an exemplary sensor array 110 appears in FIG. 3. The sensor array 110 may include a housing 114 enclosing the plurality of sensors 112. The sensor array 110 is mounted on a vehicle 116, which is a tank in the depicted embodiment, although other vehicle types are contemplated, including all manner of overland vehicles, watercraft, and aircraft. Alternatively, the vision system of the present invention may be employed in connection with other types of structures or enclosures. For example, in FIG. 2, there is shown another exemplary embodiment wherein the camera array 110 is employed in connection with an unmanned, remotely operated vehicle 118. The vehicle includes an onboard transmitter, such as a radio frequency transmitter 120 for transmitting video signals from the sensor unit 110 to a receiver 122 coupled to a computer 124. A stereo image is output to a head-mounted display 126. It will be recognized that other display types are contemplated as well.

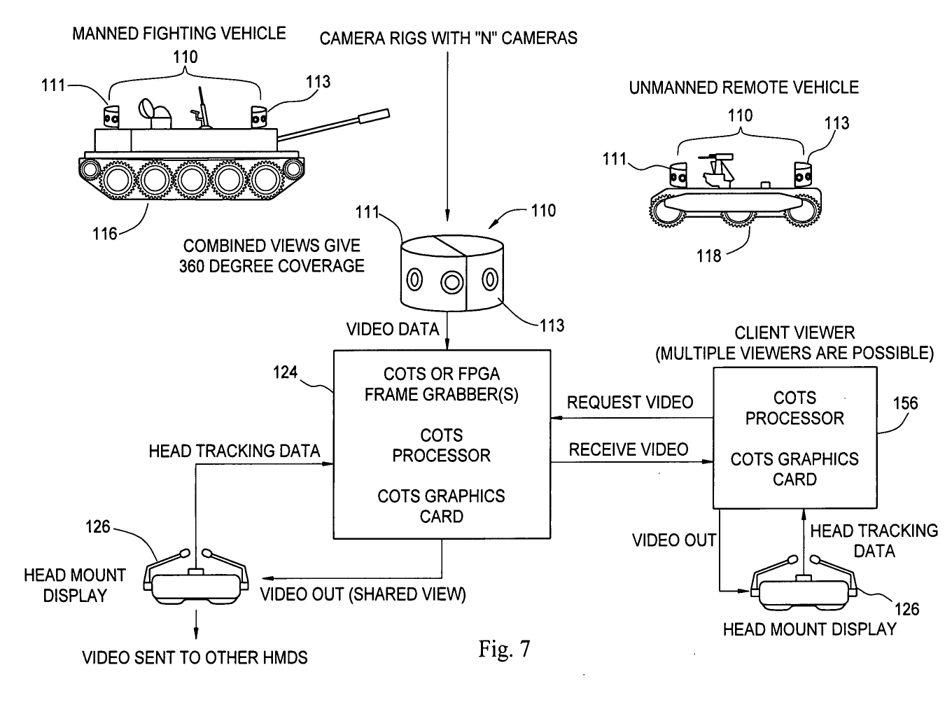

Other vision system embodiments may employ two or more sub-arrays of 1 to n sensors such that the combined fields of view for the sensors cover the entire 360-degree area around the vehicle, structure, or enclosure. The images from the sensors can then be fused together to obtain the panoramic view. Such embodiments allow the sensor sub-arrays to be distributed within a limited area and still provide the panoramic views necessary for stereo viewing. For example, FIG. 7 illustrates such a distributed embodiment in which the sensor array 110 comprises two 180-degree sensor arrays 111 and 113, which may be displaced from each other, e.g., at forward and rear portions of the vehicles. Other sub-array configurations and placements are also contemplated.

As best seen in the schematic depiction in FIG. 4, the sensor units 112 are equally radially spaced about a center point 128. Each unit 112 includes a lens assembly 130 which focuses light from a field of view 132 onto an image sensor 134 which may be, for example, a CCD array, a CMOS digital detector array, or other light-sensitive element array. The lens assembly 130 may have a fixed focal length, or, may be a zoom lens assembly to selectively widen or narrow the field of view. Each sensor 112 outputs a two-dimensional image of its respective field of view 132 and passes it to a computer-based information handling system 124.

Preferably, the image sensing elements 134 are color sensors, e.g., in accordance with a red-green-blue or other triadic color scheme. Optionally, additional sensor elements, sensitive to other wavelengths of radiation such as ultraviolet or infrared, may be provided for each pixel. In this manner, infrared and/or ultraviolet images can be acquired concurrently with color images.

In the embodiment of FIG. 1, the image outputs from the plural cameras in the sensor array are passed to a multiplexer 136. A frame grabber 138 is employed to receive the video signals from the sensors 112 and convert the received video frames into digital image representations, which may be stored in a memory 140 of the computer system 124. Alternatively, the image sensors 112 may pass the acquired image as digital data directly to the computer system 124, which may be stored in the memory 140.

An image-processing module 142 collects and sorts the video images from the multiple cameras 112. As is best seen in FIG. 4, the cameras 112 are arranged in a circular array, such that the fields of view 132 extend radially outwardly from the center 128. Alternatively, the cameras may be arranged into partial circular subarrays, which subarrays may be separated as illustrated in FIG. 7. In preferred embodiments, the distance between adjacent cameras in the array 110 is approximately 65 mm, which is about the average distance between human eyes. In the depicted preferred embodiment, the fields of view of adjacent cameras 112 overlap by about 50 percent. For example, with a field of view of 45 degrees, the camera setup would have a radius 144 of 6.52 inches to allow 16 cameras 112 to be spaced 65 mm apart about the circumference of the circle. It will be recognized that other numbers of cameras, camera separation distances, and fields of view may be employed.

A panoramic image processor 146 generates two angularly displaced panoramic imagers. The angularly displaced images may be generated by a number of methods. In certain embodiments, as best illustrated in FIG. 4, the panoramic image processor 146 fuses the left half of each of the images from the sensors 112 together to form a first uninterrupted cylindrical or spherical panoramic image. The module 146 similarly fuses the right half of each of the images from the sensors 112 together to form a second uninterrupted cylindrical or spherical panoramic image. The first and second panoramic images provide a continuous left eye and right eye perspective, respectively, for a stereo 3-D view of the outside world.

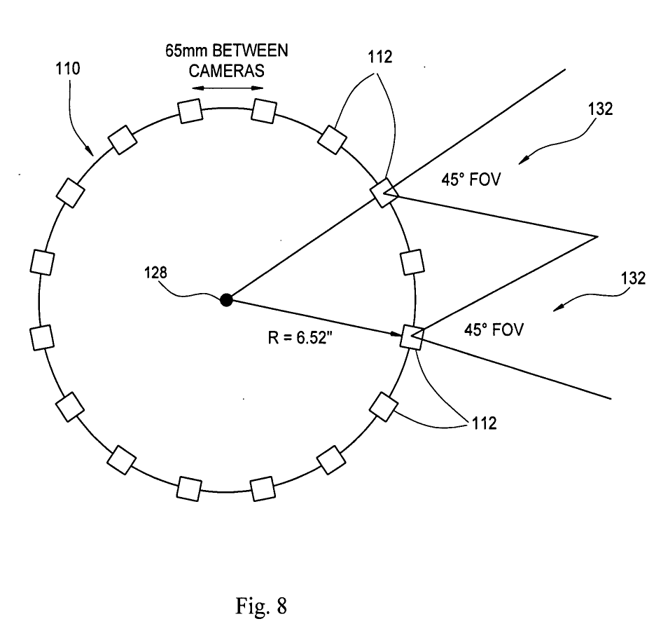

An alternative method of generating the stereo panoramic images from the sensors 112 is shown in FIG. 8. With the sensors 112 in the array 110 numbered sequentially from 1 in a counterclockwise direction, the full images from odd numbered sensors are fused together to form a first uninterrupted cylindrical or spherical panoramic image. Similarly, the full images from the even numbered sensors are fused together to form a second uninterrupted cylindrical or spherical panoramic image. Preferably, there is an even number of sensors. The first and second panoramic images provide a continuous left eye and right eye perspective for a stereo 3-D view of the outside world. With this method, the display software reassigns the left and right eye view as the operator view moves between sensor fields of view.

The left eye perspective image is presented to the left eye of the operator and the right eye perspective image is presented to the right eye of the operator via a stereoscopic display 126. The differences between the left eye and right eye images provide depth information or cues which, when processed in the visual center of the brain, provide the viewer with a perception of depth. In the preferred embodiment, the stereoscopic display 126 is head-mounted display of a type having a left-eye display and a right-eye display mounted on a head-worn harness. Other types of stereoscopic displays are also contemplated, as are conventional two-dimensional displays.

In operation, the display 126 tracks the direction in which the wearer is looking and sends head tracking data 148 to the processor 142. A stereo image generator module 150 retrieves the corresponding portions of the left and right eye panoramic images to generate a stereoscopic image. A graphics processor 152 presents the stereoscopic video images in human viewable form via the display 126. The video signal 154 viewable on the display 126 can be shared with displays worn by other users.

In a preferred embodiment, one or more client computer-based information handling systems 156 may be connected to the host system 124. The client viewer includes a processor 158 and a graphics card 160. Head tracking data 148 is generated by the client display 126 is received by the processor 158. The client computer 156 requests those portions of the left and right panoramic images to generate a stereo view which corresponds to the direction in which the user is viewing. The corresponding video images are forwarded to the computer 156 and output via the graphics processor 160.

In this manner, multiple viewers may access and view portions of the panoramic images independently. In the embodiment of FIG. 1, only one client computer system 156 is shown for ease of exposition. However, any desired number of client computers 156 may be employed to provide independent stereoscopic viewing capability to a desired number of users. In the embodiment depicted in FIG. 1, the stereo 3-D view provides relative depth information or cues which can be perceived independently by multiple users, such as the driver of the tank 116 and the weapons officer, greatly increasing their effectiveness.

In certain embodiments, a image representation of the user's location, such as the vehicle 116, which may be a 2-D or 3-D representation, such as an outline, wire frame, or other graphic representation of the vehicle 116, may be superimposed over the display image so that the relative positions of the vehicle 116 versus other objects in the video streams can be determined by the driver or others in the crew. This is important, as it is now the case that drivers routinely collide with people and objects due to an inability to perceive the impending collision, which may be due to a lack of view or the inability to perceive the relative depth of objects in the field of view. This is of particular concern for large land vehicles such as tanks, sea vehicles such as ships, and air vehicles such as helicopters. Preferably, the vehicle overlay is selectively viewable, e.g., via an operator control 162.

The views are preferably made available in real-time to one or more operators via a panoramic (e.g., wide field of view), ultra high-resolution head mount display (tiled near eye displays with N per eye) while tracking where they are looking (the direction the head is pointed relative to the sensor array 110) in order to provide the appropriate view angle. This may be accomplished using OpenGL or other graphics image display techniques. As used herein, the term “real-time” is not intended to preclude relatively short processing times.

In the depicted preferred embodiment of FIG. 1, multiple users may have to access the same sensor, with multiple users looking in the same direction, or, more importantly, with multiple users looking in stereo 3-D in independent directions. This enables collaboration among multiple users; say among a weapons officer and driver, as well as diverse use of the sensor such as search in multiple directions around a vehicle at the same time. A non-limiting example of such collaboration includes a driver who notices a threat with a rocket propelled grenade (RPG) at 11 o'clock. The driver can relay this to the weapons officer via audio and the weapons officer can immediately view the threat in his display, with the same view the driver is seeing. Through the use of the overlaid remote weapons system view in wide field of view (WFOV) display, the weapons officer can initiate automatic slewing of the remote weapon to the threat while accessing the threat and the possibility for collateral damage from firing at the threat and very rapidly and accurately neutralize the threat, potentially before the threat has a chance to take action. Locating the coordinates of a point in space (x, y, z) enables the very precise targeting of that point. Having other sensor(s) integrated as video overlays on the WFOV display, such as a remote weapons system camera output video mapped into the video from the spherical or cylindrical sensor 110 output dramatically reduces operator loading and both reduces time and enhances decision cycles. This provides the best of both the pan-tilt-zoom functionality of the weapons camera(s) and the WFOV of the present vision system, thereby dramatically increasing the utility and safety for the user.

In certain embodiments, a distance calculation module 164 may also utilize the stereoscopic images to calculate the coordinates of one or more objects located within the field of view. In the preferred embodiment wherein the cameras are substantially aligned horizontally, horizontal pixel offsets of an imaged object in the field of view of adjacent cameras 112 can be used to measure the distance to that object. It will be recognized that, in comparing adjacent images to determine the horizontal pixel offset, some vertical offset may be present as well, for example, when the vehicle is on an inclined surface. Depending on the type of vehicle, enclosure, etc., non-horizontal camera arrays may also be employed.

By way of non-limiting example, the calculation of the coordinates is particularly useful where the vehicle is being fired upon by a sniper or other source and the vehicle operator attempts to return fire. A vehicle embodying or incorporating the present vision system may acquire angularly displaced images of the flash of light from the sniper's weapon, which may then be located in real-time within the 3-D stereo view. The coordinates of the flash can then be calculated to give the vehicle operator(s) the approximate x, y, and z data for the target. This distance to the target can then be factored in with other ballistic parameters to sight in the target.

FIG. 5 illustrates the manner of calculating the distance to an object appearing in the field of view (FOV) of adjacent cameras 112. The distance 166 to an object 168 may be calculated by multiplying the distance 170 between adjacent cameras 112 in the array 110 by the tangent of angle θ. The angle θ is equal to angle Φ minus 90 degrees and the angle Φ, in turn, is the inverse tangent of an offset 172 divided by a factor 174. The offset value 172 is the calculated horizontal offset between the left and right image of the adjacent cameras 112 and the factor 172 is a predetermined value calculated at calibration. The distance 166 to the object 168 can thus be calculated as follows:
Object Distance (166)=Camera Separation (170)×Factor (174)/Offset (172).

In certain embodiments, objects in the acquired images may be modeled in 3-D using a 3-D model processor 176. By using the x and y coordinates of an object of interest (e.g., as calculated using the position of the object on the 2-D sensors 134 of the cameras 112 in combination with the distance to the object, or, the z coordinate), the position of the object of interest relative to the observer can be determined. By determining the three-dimensional coordinates of one or more objects of interest, a 3-D model of the imaged scene or portions thereof may be generated. In certain embodiments, the generated 3-D models may be superimposed over the displayed video image.

In some configurations, the cameras 112 may be used in landscape mode, giving a greater horizontal field of view (FOV) than vertical FOV. Such configurations will generally produce cylindrical panoramic views. However, it will be recognized that the cameras can also be used in portrait mode, giving a greater vertical FOV than horizontal FOV. This configuration may be used to provide spherical or partial spherical views when the vertical FOV is sufficient to supply the necessary pixel data. This configuration will generally require more cameras because of the smaller horizontal field of view of the cameras.

The sensors may be of various types (e.g., triadic color, electro-optical, infrared, ultraviolet, etc) and resolutions. In certain embodiments, sensors with higher resolution than is needed for 1:1 viewing of the scenes may be employed to allow for digital zoom without losing the resolution needed to provide optimum perception by the user. Without such higher resolution, digital zoom causes the image to be pixilated when digitally zoomed and looks rough to the eye, reducing the ability to perceive features in the scene. In addition to allowing stereo viewing, embodiments in which there is overlap between adjacent cameras 112 provide redundant views so that if a sensor is lost, the view can still be seen from another sensor that covers the same physical area of interest.

On certain embodiments, the present invention utilizes a tiled display so that a very wide FOV which is also at a high resolution can be presented to the user, thereby allowing the user to gain peripheral view and the relevant and very necessary visual queues that this enables. Since the human eye only has the ability to perceive high resolution in the center of the FOV, the use of high resolution for peripheral areas can be a significant waste of system resources and an unnecessary technical challenge. In certain embodiments, the resolution of the peripheral areas of the FOV can be displayed at a lower resolution than the direct forward or central portion of the field of view. In this manner, the amount of data that must be transmitted to the head set is significantly reduced while maintaining the WFOV and high resolution in the forward or central portion of the view.

The functional components of the computer system 124 have been described in terms functional processing modules. It will be recognized that such modules may be implemented in hardware, software, firmware, or combinations thereof. Furthermore, it is to be appreciated that any or all of the functional or processing modules described herein may employ dedicated processing circuitry or, may be employed as software or firmware sharing common hardware.

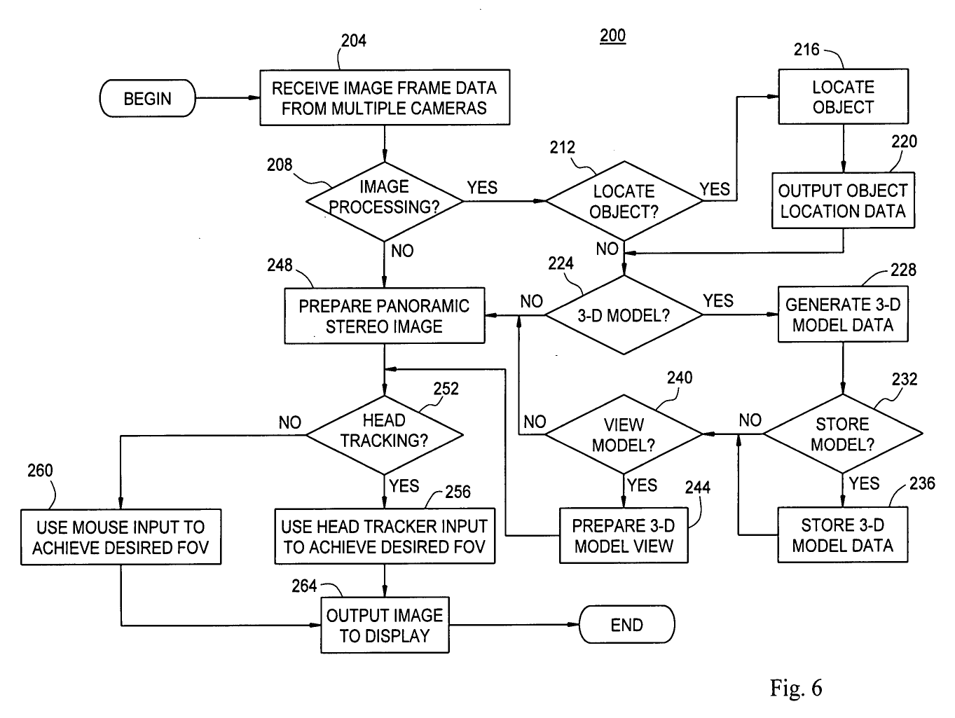

Referring now to FIG. 6, there appears a flow diagram outlining an exemplary method 200 in accordance with the present invention. At step 204, image data is received from the cameras 112 in the array 110. The image data may be received as digital data output from the cameras 112 or as an analog electronic signal for conversion to a digital image representation. At step 208, it is determined whether additional image processing such as object location or 3-D modeling is to be performed. Such processing features are preferably user selectable, e.g., via operator control 162.

If one or more processing steps are to be performed, e.g., based on user-selectable settings, the process proceeds to step 212 where it is determined if the coordinates of an imaged object are to be calculated. If one or more objects are to be located, the process proceeds to step 216 and the coordinates of the object of interest are calculated based on the horizontal offset between adjacent sensor units 112, e.g., as detailed above by way of reference to FIG. 5. The object coordinates are output at step 220 and the process proceeds to step 224. Alternatively, in the event object coordinates are not to be determined in step 212, the process proceeds directly to step 224.

At step 224, it is determined whether a 3-D model is to be generated, e.g., based on user selectable settings. If a 3-D model is to be generated at step 224, the process proceeds to generate the 3-D model at step 228. If the 3-D model is to be stored at step 232, the model data is stored in a memory 178 at step 236. The process then proceeds to step 240 where it is determined if the 3-D model is to be viewed. If the model is to be viewed, e.g., as determined via a user-selectable parameter, the 3-D model is prepared for output in human-viewable form at step 244 and the process proceeds to step 252.

If a 3-D model is not to be created at step 224, or, if the 3-D model is not to be viewed at step 244, the process proceeds to step 248 and left eye and right eye panoramic stereo views are generated. If the field of view of the selected image, i.e., the panoramic stereo image or 3-D model image, is to be displayed selected based on head tracking in step 252, then head tracker data is used to select the desired portion of the panoramic images for display at step 256. If it is determined that head tracking is not employed at step 252, then mouse input or other operator input means is used to select the desired FOV at step 260. Once the desired field of view is selected at step 256 or step 260, a stereo image is output to the display 126 at step 264. The process then repeats to provide human viewable image output at a desired frame rate.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A panoramic camera system, comprising:
a circumferential array of camera units mounted in a common plane, each camera unit including one or more lenses for focusing light from a field of view onto an array of light-sensitive elements;
a panoramic image generator for combining electronic image data from the multiplicity of the fields of view to generate electronic image data representative of a first 360-degree panoramic view and a second 360-degree panoramic view, said first and second panoramic views being angularly displaced with respect to each other; and
a first stereographic display system for retrieving operator-selectable portions of said first and second panoramic views and outputting the user selectable portions in human viewable form.

2. The panoramic camera system of claim 1, wherein said camera units are mounted in a generally horizontal plane.

3. The panoramic camera system of claim 1, wherein said circumferential array is selected from:
a circular array; and
a plurality of partial circular arrays.

4. The panoramic camera system of claim 1, wherein the field of view of each camera unit is overlapping with the fields of view of adjacent ones of said camera units in said circumferential array.

5. The panoramic camera system of claim 1, further comprising:
said display system including first and second display screens presenting angularly displaced images separately to first and second eyes of a viewer to create a perception of depth.

6. The panoramic camera system of claim 1, wherein the electronic image data acquired by every second camera in the circumferential array is used to generate the first panoramic view and the electronic image data acquired by every other camera in the circumferential array is used to generate the second panoramic view.

7. The panoramic camera system of claim 1, wherein electronic image data representative of a left side of the field of view acquired by each camera in the circumferential array is used to generate the first panoramic view and electronic image data representative of a right side of the field of view acquired by each camera in the circumferential array is used to generate the second panoramic view.

8. The panoramic camera system of claim 1, further comprising one or both of:
a three-dimensional model generator for transforming at least a portion of the first and second panoramic views into a three-dimensional model; and
a distance calculator for determining the relative coordinates of an imaged object based on horizontal pixel offsets of the imaged object in the field of view of adjacent cameras in said circumferential array.

9. The panoramic camera system of claim 1, wherein the first and second panoramic views are selected from cylindrical and spherical panoramic views.

10. The panoramic camera system of claim 1, wherein said camera units are sensitive to one or more of visible, ultraviolet, and infrared radiation.

11. The panoramic camera system of claim 1, further comprising:
a transmitter for transmitting acquired image data to a remote location.

12. The panoramic camera system of claim 1, wherein said stereographic display is adapted to be worn by a user.

13. The panoramic camera system of claim 12, further comprising:
a sensor for detecting a direction in which a user is looking relative to said array; and
a processor for retrieving portions of the first and second panoramic views which correspond to the direction detected by said sensor.

14. The panoramic camera system of claim 1, further comprising:
one or more additional stereographic display systems for displaying portions of said first and second panoramic views in human viewable form.

15. The panoramic camera system of claim 14, wherein at least one of said one or more additional stereographic display systems includes means for retrieving operator-selectable portions of said first and second panoramic views and outputting the user selectable portions in human viewable form independently of said first stereographic display system.

16. A method of providing a video display of a selected portion of a panoramic region, comprising:
acquiring image data representative of a plurality of fields of view with a circumferential array of camera units mounted in a common plane, each camera unit including one or more lenses for focusing light from a field of view onto an array of light-sensitive elements;
combining electronic image data from the multiplicity of the fields of view to generate electronic image data representative of a first 360-degree panoramic view and a second 360-degree panoramic view, said first and second panoramic views being angularly displaced with respect to each other; and
retrieving selected portions of said first and second panoramic views; and
converting the selected portions of the first and second panoramic views into human viewable form.

17. The method of claim 16, wherein said cameras are mounted in a generally horizontal plane.

18. The method of claim 16, further comprising:
presenting angularly displaced images separately to first and second eyes of a viewer to create a perception of depth.

19. The method of claim 18, further comprising:
superimposing a graphical image representative of a location of the user onto the images presented to the eyes of the user.

20. The method of claim 16, wherein the field of view of each camera unit is overlapping with the fields of view of adjacent ones of said camera units in said circumferential array.

21. The method of claim 16, further comprising:
outputting selected portions of said first and second panoramic views to a plurality of human-viewable stereographic displays.
